(19) United States
(12) Patent Application Publication
(10) Pub. No.: US 2007/0009706 A1
(43) Pub. Date: Jan. 11, 2007

(54) DECORATIVE EXTERIOR WALL PANEL

(76) Inventor: William (Bill) J. BECK, Calgary (CA)

Correspondence Address: SEAN W. GOODWIN, 222 PARKSIDE PLACE, 602-12 AVENUE S.W., CALGARY, AB, T2R 1J3, CA

(21) Appl. No.: 11/163,704

(22) Filed: Oct. 27, 2005

(30) Foreign Application Priority Data
Jul. 8, 2005 (CA) 2511758

(51) Int. Cl. B32B 3/06

(52) U.S. Cl. 428/99

(57) ABSTRACT

A coating for an exterior surface contains acrylic resin, silica sand and sufficient reinforcing fibers to provide surface coverage of fibers of 5-50%. Different acrylic resins may be mixed to vary the resilience and hardness of the coating. Exterior panels are prepared using the coating by spraying the coating on a foam sheet. Designs, such as grout lines resembling bricks, uneven rocks or blocks are made by first applying the design to the foam and then rolling or spraying the coating over the imprinted foam. Designs may be applied using heat or solvent or other techniques. The panels made are fastened to the exterior surface of a structure using fasteners or adhesives. The coating may be used as the adhesive and may also be used to caulk between adjacent panels.

### FIELD OF THE INVENTION

Embodiments of the invention relate to exterior wall panels and, more particularly, to aesthetically pleasing panels for installation on an exterior wall of a static structure, such as a building.

### BACKGROUND OF THE INVENTION

Structures, such as commercial and residential buildings, are typically finished on an exterior surface with an aesthetic, decorative finish. Traditionally, the exterior finishes have been natural materials, such as rock, and manmade materials, such as brick. Typically, however such materials are very expensive and require specially trained artisans and installers to properly prepare and install such materials.

Veneer-type panels using natural and brick materials have been created however these type of exterior panels are still relatively expensive as they are labor intensive to manufacture.

In order to reduce the cost and labor involved while maintaining the aesthetics of a rock or brick finish and the insulating properties associated therewith, it is known to provide exterior surface materials which are made of a variety of composite materials and the like.

One such technique is to provide a multilayer finish to a wall comprising an inner styrofoam layer covered with a fiberglass wire mesh and fastened, using fasteners or adhesives, to the wall's exterior surface. The fiberglass wire mesh is coated with a top coat which adheres to the mesh followed by a base coat and a finish coat. One such material used as the top and base coat is a flexible joint compound such as Sto Gold Fill™ available from Sto Corp. of Atlanta Ga. USA 30331. The finish coat is typically a waterproof coating such as Sto Gold Coat™ also available from Sto Corp. of Atlanta Ga. USA 30331. The joint compound is typically applied using a trowel and the finish coat is applied using a roller. Skill is necessary to provide a desirable finish, such as a stippled stucco look, to the surface. Added effects, which may be created on the surface of the joint compound, rely on the artistic ability and the skill of the installer.

Construction systems are also known, using complete composite wall panels which comprise an inner layer of foam, such as a polystyrene foam, covered with coatings, including cementitious materials. One such system is taught in U.S. Pat. No. 4,774,794 to Grieb wherein a fiberglass mat is positioned over a foam core and the mat is subsequently coated with a cementitious material containing fiberglass roving and a polymer adhesive acrylic material. The mixture is laid over the fiberglass mat wherein it penetrates the mat and adhesively bonds the coated mat to the foam core. Structures are constructed of the blocks created using the method taught.

Others, such as U.S. Pat. No. 4,944,127 to Clear, utilize a plurality of grooves on an outer surface of a foam layer to improve a mechanical lock between a cementitious layer applied to the foam layer and the foam layer itself.

There remains interest in the industry to provide an exterior panel having an aesthetically pleasing surface that can be fastened to an exterior wall of both new and existing structures and which is capable of imitating other conventional exterior surface materials such as rock and brick or providing other architectural designs thereon. It is desired that coatings applied to the exterior surface of such panels be strong, durable and relatively impenetrable yet breathable to prevent moisture buildup between the panel and the exterior surface of the structure. Further, the panel should be relatively inexpensive, simple to manufacture and easy to install.

### SUMMARY

A unique exterior surface coating is provided for coating exterior surfaces and for manufacturing and installing exterior wall panels which are durable and are not readily penetrated. The coating comprises at least one acrylic resin; silica sand; and an effective amount of reinforcing fibers to provide a surface coverage of fibers from about 5% to about 50% when applied to the exterior surface.

In an embodiment of the invention, the resin comprises a mixture of hard and soft acrylic resin to provide a resilient resin mixture which is combined with an effective amount of glass fibers to provide about 20% surface coverage of fibers, The glass fibers are added to one part of resin and mixed therein after which 2 to 3 parts by volume of a fine silica sand are added. The coating is mixed after which it can be applied to the exterior surface using conventional means such as a texture spray machine or by rolling.

In another embodiment, an exterior wall panel adapted for application to a surface of a static structure is manufactured using the method according to another embodiment of the invention. The panel comprises: a foam sheet; the coating, as described, applied to an exterior surface of the foam sheet; and means adapted for attaching the wall panel to the surface of the static structure. The panel can be fastened to the exterior surface using conventional fasteners and adhesives or alternatively can be fastened using the coating as an adhesive.

Preferably, a pattern, design or surface texture is imparted to the foam sheet prior to the application of the coating. The markings are imparted using a variety of techniques including, but not limited to, the application of heat, a heated template or solvent to the surface of the foam.

The panel may be manufactured having tongue and groove edges which are engaged between adjacent panels for forming a substantially continuous decorative surface. Alternately the panels may simply be butted against one another and the space between the adjacent panels filled with caulking or with the coating.

### BRIEF DESCRIPTION OF THE DRAWINGS

FIG. 1 is a perspective view illustrating a plurality of embodiments of the invention, more particularly a plurality of panels illustrating a variety of aesthetic finishes such as a uniformly sized block-like finish, an unevenly sized, cut stone-like finish and a brick-like finish;

FIG. 2 is an isometric illustrating an embodiment for applying a profiled surface or design to a foam panel using a heated template prior to applying a coating;

FIG. 3 is a side view of an embodiment for producing an overlapping strip finish;

FIG. 4 is an edge view illustrating an embodiment of a connection method between adjacent panels according to an embodiment of the invention for forming a substantially continuous decorative surface therewith;

FIG. 5 is an edge view illustrating a connection method between panels according to an embodiment of the invention for forming a substantially continuous decorative surface therewith;

FIG. 6 is a sectional top edge view illustrating an embodiment for creating a corner using a panel according to an embodiment of the invention; and

FIG. 7 is a front view of a panel formed having a single block-like finish and a plurality of fastening members extending therefrom.

### DETAILED DESCRIPTION OF THE PREFERRED EMBODIMENT

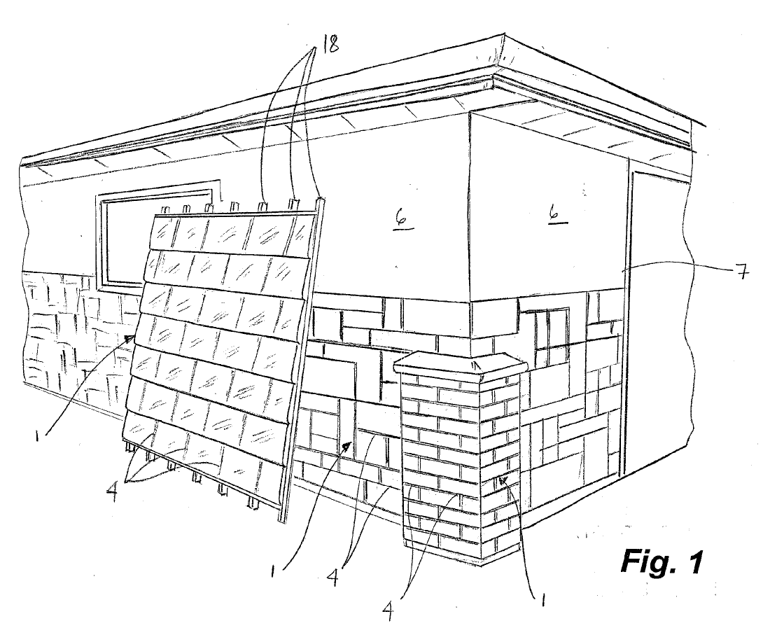

Having reference to FIGS. 1, 2, 3 and 7, exterior panels 1 of varying shapes, sizes and surface finishing are shown according to embodiments of the invention. In each embodiment the panel is manufactured using a foam sheet 2, such as Styrofoam to which a unique coating 3 is applied. Further, indicia or designs 4 may be applied to an exterior surface 5 of the foam sheet 2 prior to application of the coating 3 to achieve a plurality of decorative design finishes, as may be desired.

An embodiment of the unique coating 3 comprises a 100% acrylic resin to which reinforcing fibers and silica sand are added. Reinforcing fibers, such as those conventionally used in the concrete industry and typically ranging from about ⅛″ to about ⅝″ long and even up to about 1½″ long, are added to the resin in an effective amount so as to provide a surface coverage of fibers, when applied to the foam, in a range of from about 5% to about 50%. Most preferably, the fibers used are about ½″ long and are added to provide a surface coverage, when applied to the foam, of about 20%. The acrylic resin and fibers are first mixed, such as in a hopper, after which silica sand is added to impart additional strength, uniformity and to improve the aesthetics of the coating.

Sufficient silica sand is added in an amount sufficient to obtain a consistency which can be applied to the exterior surface 5 of the foam sheet 2 using conventional means, such as by roller or using a texture spray machine such as is known in the industry. Additionally dyes or other coloring may be added and mixed with the acrylic resin to improve the aesthetics of the finished panel 1.

In a preferred embodiment, the acrylic resin may comprise a mixture of one or more acrylic resins, such as Resin #2000 and Resin #2438 available from Akrilon Industries Inc., Calgary, Alberta, Canada. Each of the acrylic resins has a different hardness when applied and therefore when mixed together in varying amounts, the hardness and resilience of the coating can be altered as desired. In one embodiment, the acrylic resin mixture comprises about ⅓ Resin #2000 (hard) and about ⅔ Resin #2438 (soft) to produce a resilient coating which is durable and not readily penetrated.

Glass fibers, such as CONTROL™ fibers available from Nycon, Inc., Rhode Island, USA, are added to the acrylic resin or acrylic resin mixture so as to produce a surface coverage of about 20% fibers. Approximately 3 oz (0.084 kg) of fibers are added to each 5 gallon pail of acrylic resin and the fibers and acrylic are then mixed to disperse the fibers therein.

Silica sand, in an amount ranging from about 2 to about 3-5 gallon pails is then added to the acrylic/fiber mixture and the resulting coating is mixed until a uniform suspension is obtained. Preferably, fine silica sand such as 070 silica sand, available from Target Products Inc. of Burnaby, British Columbia, Canada, is used.

Therefore, in one embodiment, the coating 3 comprises about 1 part by volume of acrylic resin combined with from about 2 to about 3 parts by volume of silica sand and an effective amount of fibers to produce about 20% surface coverage of fibers when applied to the foam sheet 2.

According to embodiments of the invention, a variety of exterior surface panels 1 can be produced using the foam sheet 2 and embodiments of the coating 3, as described above. Further, the coating 3 may also be used to coat existing surfaces such as drywall, wood, concrete and the like and can be used as an adhesive for fastening panels 1 to exterior surfaces 6 of static structures 7, regardless the surface material and as a caulking compound between installed exterior surface panels 1, such as those described herein.

Preferably, desired patterns are applied to the foam sheet 2 prior to applying the coating 3. Random patterning or patterns and designs using a template can be imprinted on the exterior surface 5 of the foam 2 without a requirement for specific artistic skills for economically producing large quantities of a high quality product and the coating can be applied using conventional techniques such as spraying. Thus, reliance on artistic skills is reduced both in the manufacture and in the application of an aesthetic surface to the exterior of a building and the like.

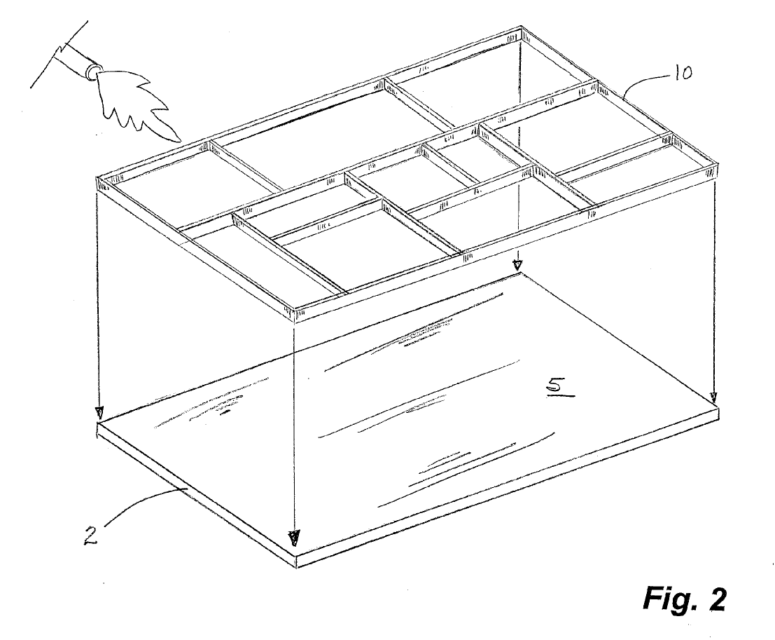

Having particular reference to FIGS. 1 and 2, in order to simulate brick or stone or other architecturally-produced design, the exterior surface 5 of the foam sheet 2 may be initially imprinted with a pattern. One method of imprinting the foam 2 as shown, is to apply a heated template 10, such as an aluminum grid, to the exterior surface of the foam sheet 2 to brand the surface 5 of the foam 2 with the pattern by melting at least a portion of the foam's surface 5. For some designs, the branding creates depressions which simulate grout lines between brick or stones. In another embodiment, not shown, a narrow heated roller is rolled along the surface of the foam to melt the depressions for creating regularly spaced lines on strips of foam for simulating a block-like finish or for other patterns as desired.

Patterns need not necessarily simulate only grout lines of regular or irregular stone and brick patterns. Other means may be used to texture the exterior surface 5 of the foam 2, such as using solvents including lacquer thinner. Such texturing may be used to simulate a hewn stone-like pattern on the surface 5 of foam 2 for creating single block-like panels. Other architectural patterns and pleasing finishes may be applied to the foam 2 using any means of marking the foam 2.

Once the exterior surface 5 of the foam 2 has been imprinted with the pattern or marking, the coating 3 is applied to the foam 2.

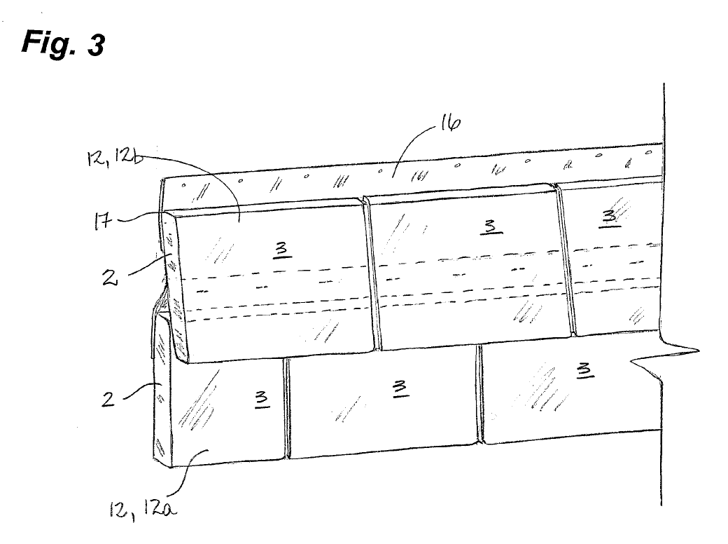

Panels 1 may be created as single sheets of foam having an overall pattern formed thereon or, as shown in FIGS. 1 and 3 may be created using elongate strips 12 of foam 2 having a pattern formed on at least a portion of each strip 12. The strips 12 can be fastened to the wall individually, using fastening means 14 such as adhesives and fasteners, or can be held together as a panel 1, such as by fabric strips 16 which are fastened to a top edge 17 of each adjacent strip 12a, 12b and extending beyond for fastening to the wall or optionally to an overlapping strip. The overlapping strips 12a, 12b may optionally be supported by vertical frame members 18 for installation on an exterior wall surface.

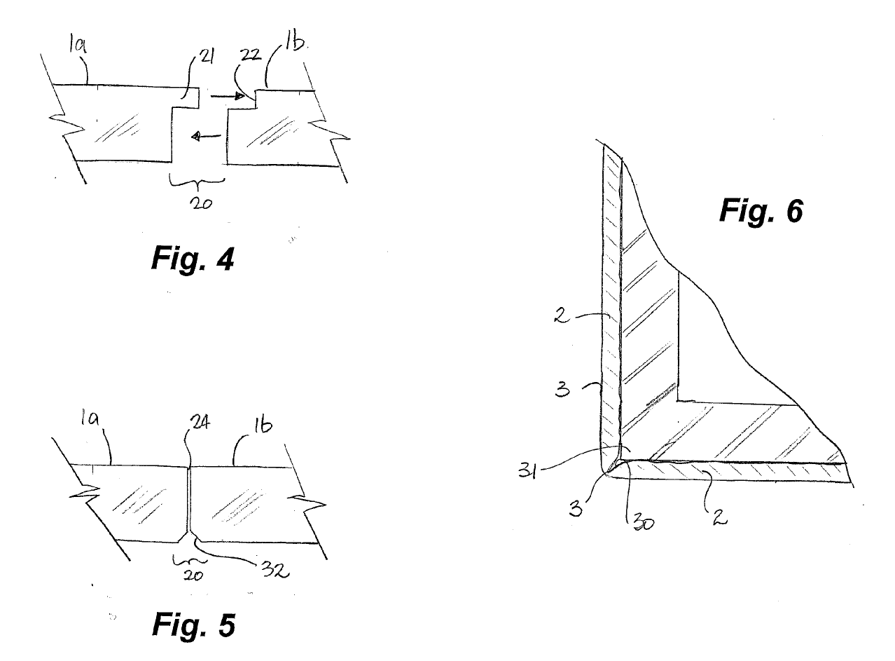

The panels 1 are typically fastened to the exterior surface of a wall using fastening means such as fasteners or adhesives. Where adjacent panels 1a, 1b are installed to create a substantially continuous decorative surface, joints 20 between the adjacent panels 1a, 1b may be tongue 21 and groove 22 joints as seen in FIG. 4 In the case of tongue and groove joints 21, 22, opposing sides of each panel 1a may be formed having either a tongue 21 or a groove 22 which is mated with a groove 22 or tongue 21 on the adjacent panel 1b. Further, all sides of a panel 1 may be formed having tongue or groove connections to permit installing panels side by side and above and below one another.

Optionally, panels 1a, 1b may simply be positioned side by side against one another, as seen in FIG. 5, any space 24 between the adjacent panels 1a, 1b, being sealed with caulking.

As shown in FIG. 6 and largely as a result of the resilient nature of the reinforced acrylic coating 3, a portion 30 of the foam sheet 2 may be removed from behind the coating 3, such as a V-notch, so as to permit the panel 1 to be folded and wrapped around a corner 31 in an exterior wall eliminating the need to use a separate corner bead. Alternatively (not shown), panels 1a, 1b may be positioned to abut adjacent each side of the corner 31 and the opening therebetween at the corner 31 may be caulked.

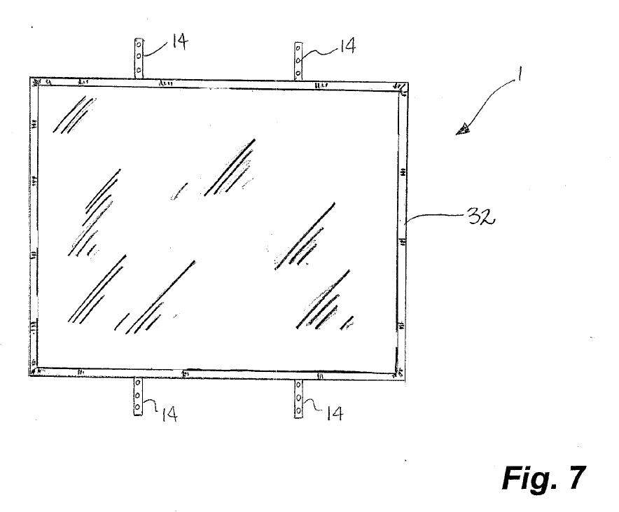

As shown in FIGS. 5 and 7, edges of the panel 1 may be formed having a bevel 32.

1. A coating for an exterior surface comprising:
at least one acrylic resin;
silica sand; and
an effective amount of reinforcing fibers to provide a surface coverage of from about 5% to about 50% when applied to the exterior surface.

2. The coating as described in claim 1 wherein the at least one acrylic resin comprises about 1 part by volume and the silica sand comprises from about 2 parts to about 3 parts by volume.

3. The coating as described in claim 1 wherein the at least one acrylic resin further comprises varying volumes of a first hard acrylic resin and varying volumes of a second soft acrylic resin for varying the hardness of the exterior surface.

4. The coating as described in claim 1 wherein the reinforcing fibers are glass fibers in a range of from about ⅛″ to about ⅝″.

5. The coating as described in claim 4 wherein the glass fibers are about ½″ and the effective amount of the reinforcing fibers is added to provide a surface coverage of about 20% when applied to the exterior surface.

6. An exterior wall panel adapted for application to a surface of a static structure comprising:
a foam sheet;
a coating applied to an exterior surface of the foam sheet, the coating comprising:
at least one acrylic resin;
silica sand; and
an effective amount of reinforcing fibers to provide a surface coverage of from about 5% to about 50% when applied to the exterior surface; and
attachment means adapted for attaching the wall panel to the surface of the static structure.

7. The exterior wall panel as described in claim 6 wherein the exterior surface of the foam sheet is imprinted with a pattern prior to coating.

8. The exterior wall panel as described in claim 7 wherein the imprinting of the surface of the foam sheet is by application of heat thereto.

9. The exterior wall panel as described in claim 8 wherein the application of heat to the foam sheet is by applying a heated template thereto.

10. The exterior wall panel as described in claim 7 wherein the imprinting of the surface of the foam sheet is by application of a solvent thereto.

11. The exterior wall panel as described in claim 6 wherein the exterior wall panel further comprises at least two opposing edges, a first formed having a tongue and a second formed having a groove for engaging the tongue or groove of an adjacent exterior wall panel for forming a continuous decorative surface.

12. The exterior wall panel as described in claim 6 wherein the decorative wall panel further comprises two or more opposing edges formed having either a tongue or a groove for engaging a tongue or a groove on an adjacent decorative wall panel for forming a continuous decorative surface.

13. The exterior wall panel as described in claim 6 wherein the attachment means are fasteners.

14. The exterior wall panel as described in claim 6 wherein the attachment means is adhesive.

15. The exterior wall panel as described in claim 14 wherein the adhesive is the coating of claim 6.

16. A method for constructing an exterior wall panel adapted for application to a surface of a static structure comprising:
providing a foam sheet;
applying a coating to at least an exterior surface of the foam sheet, the coating comprising
at least one acrylic resin;
silica sand; and
an effective amount of reinforcing fibers to provide a surface coverage of from about 5% to about 50% when applied to the exterior surface.

17. The method as described in claim 16 further comprising imprinting an exterior surface of the foam sheet with a pattern prior to applying the coating.

18. The method as described in claim 17 further comprising imprinting the exterior surface of the foam layer by application of heat thereto.

19. The method as described in claim 18 further comprising imprinting the exterior surface of the foam layer with heat by application of a heated template thereto.

20. The method as described in claim 17 further comprising imprinting the exterior surface of the foam layer by application of solvent thereto.

21. A panel according to the method of claim 18.

22. A method adapted for covering an external surface of a static structure comprising:
providing one or more panels according to claim 16;
fastening the one or more panels to the external surface of the static structure.

23. The method as described in claim 22 further comprising fastening the one or more panels to the external surface using fasteners.

24. The method as described in claim 22 further comprising fastening the one or more panels to the external surface using adhesive.

25. The method as described in claim 22 further comprising fastening the one or more panels to the external surface using the coating.

26. The method of claim 16 further comprising:
providing attachment means adapted for attaching the exterior wall panel to the surface of the static structure.
